(19) United States
(12) Patent Application Publication
(10) Pub. No.: US 2019/0187309 A1
(43) Pub. Date: Jun. 20, 2019

(54) IMAGING PANEL AND METHOD FOR PRODUCING SAME

(71) Applicant: Sharp Kabushiki Kaisha, Sakai City, Osaka (JP)

(72) Inventor: KATSUNORI MISAKI, Yonago-shi,Tottori (JP)

(21) Appl. No.: 16/322,966

(22) PCT Filed: Jul. 31, 2017
(86) PCT No.: PCT/JP2017/027769

§ 371 Date: Feb. 3, 2019

(30) Foreign Application Priority Data
Aug. 3, 2016 (JP) 2016-153047

(51) Int. Cl. G01T 7/00; G01T 1/20

(52) U.S. Cl. CPC G01T 7/00; G01T 1/2018

(57) ABSTRACT

Provided is an X-ray imaging panel in which off-leakage current can be suppressed, and a method for producing the same. An imaging panel generates an image based on scintillation light obtained from X-rays transmitted through an object. The imaging panel includes, on the substrate, a thin film transistor, an insulating resin film provided on the thin film transistor, an insulating protection film and a lower electrode provided on the insulating resin film, a photoelectric conversion layer provided on the lower electrode, and an upper electrode provided on the photoelectric conversion layer. The insulating resin film has an opening CH1 on the drain electrode, and the insulating protection film is arranged on an outer side with respect to the opening CH1 so as to be separated from the opening CH1. The lower electrode overlaps with a part of the insulating protection film, and is connected with the drain electrode at the opening CH1. The insulating resin film is covered with at least either the lower electrode or the insulating protection film in an area where the photoelectric conversion layer is provided.

### TECHNICAL FIELD

The present invention relates to an imaging panel and a method for producing the same.

### BACKGROUND ART

An X-ray imaging device that picks up an X-ray image with an imaging panel that includes a plurality of pixel portions is known. In such an X-ray imaging device, for example, p-intrinsic-n (PIN) photodiodes are used as photoelectric conversion elements, and irradiated X-rays are converted into charges by the PIN photodiodes. Converted charges are read out by thin film transistors (hereinafter also referred to as TFTs) that are caused to operate, the TFTs being provided in the pixel portions. With the charges being read out in this way, an X-ray image is obtained.

JP-A-2015-119113 discloses a photoelectric conversion element array unit in which PIN photodiodes are used. In the configuration disclosed in JP-A-2015-119113, electrodes are provided on the top surface and the lower surface of each PIN photodiode, and a transparent insulating resin film is provided under the electrodes on the lower surface side.

### SUMMARY OF THE INVENTION

Incidentally, each of the semiconductor layers that compose a PIN photodiode, that is, the p-layer, the i-layer, and the n-layer, can be formed by using a plasma chemical vapor deposition (CVD) device. The higher the temperature at which the semiconductor layers are formed is, better diode properties are obtained. In a case where, however, each semiconductor layer is formed at a high temperature on the insulating resin film so as to cover the lower electrode as is disclosed in JP-A-2015-119113, carbon gas is generated from the insulating resin film, which impairs the properties of the PIN photodiode. To suppress the generation of carbon gas, for example, a configuration as illustrated in FIG. 9 can be proposed in which an inorganic insulating film 520 is formed so as to cover the insulating resin film 510, and a lower electrode 530, an n-layer 541, an i-layer 542, and a p-layer 543 are laminated in this order on the inorganic insulating film 520.

By covering the insulating resin film 510 with the inorganic insulating film 520, each of the semiconductor layers 541 to 543 of the PIN photodiode can be formed under a high temperature. In this case, however, the inorganic insulating film 520 and an opening 520a thereof have to be formed in an opening 510a provided in the insulating resin film 510 for connecting the lower electrode 530 with a drain electrode 550d of a TFT 550. When the opening 520a of the inorganic insulating film 520 is formed, a resist is applied to the opening 510a, but it is difficult to pattern the resist in a tapered shape in the opening 510a. The opening 520a of the inorganic insulating film 520 therefore has a cross section approximately vertical to the insulating resin film 510, and the lower electrode 530 is formed along the shape of the opening 520a. As a result, it is unlikely that the semiconductor layer 541 formed on the lower electrode 530 would be sufficiently formed in the opening 520a, and the film of the semiconductor layer 541 becomes discontinuous at the step portion of the opening 520a. In this case, the lower electrode 530 is not completely covered with the n-layer 541, thereby resulting in that the lower electrode 530 and the i-layer 542 are in contact with each other, which would cause off-leakage current to be generated.

It is an object of the present invention to provide an imaging panel which off-leakage current can be suppressed.

An imaging panel of the present invention with which the above-described problem is solved is an imaging panel that generates an image based on scintillation light that is obtained from X-rays transmitted through an object, and the imaging panel includes: a substrate; a thin film transistor that is formed on the substrate; an insulating resin film that is provided on the thin film transistor and has an opening on a drain electrode of the thin film transistor; an insulating protection film that is arranged on an outer side with respect to the opening on the insulating resin film so as to be separated from the opening; a lower electrode that is provided on the insulating resin film, overlaps with a part of the insulating protection film, and is connected with the drain electrode at the opening; a photoelectric conversion layer that is provided on the lower electrode, and converts the scintillation light into charges; and an upper electrode that is provided on the photoelectric conversion layer.

With the present invention, an imaging panel in which off-leakage current can be suppressed can be provided.

### BRIEF DESCRIPTION OF DRAWINGS

FIG. 1 schematically illustrates an X-ray imaging device in an embodiment.

FIG. 2 schematically illustrates a schematic configuration of the imaging panel illustrated in FIG. 1.

FIG. 3 is an enlarged plan view illustrating one pixel portion of an imaging panel 1 illustrated in FIG. 2.

FIG. 4 is a cross-sectional view of the pixel illustrated in FIG. 3, taken along the line A-A.

FIG. 5A is a cross-sectional view illustrating a step of forming a first insulating film on a gate insulating film and a TFT formed on a substrate.

FIG. 5B is a cross-sectional view illustrating a step of forming a contact hole CH1 in an insulating film 103 illustrated in FIG. 5A.

FIG. 5C is a cross-sectional view illustrating a step of forming an insulating film 104 on the insulating film 103 illustrated in FIG. 5B.

FIG. 5D is a cross-sectional view illustrating a step of forming an opening of the insulating film 104 on a contact hole CH1 illustrated in FIG. 5C.

FIG. 5E is a cross-sectional view illustrating a step of forming an insulating film 120 on the insulating film 104 illustrated in FIG. 5D.

FIG. 5F is a cross-sectional view illustrating a step of forming a resist on the insulating film 120 illustrated in FIG. 5E, outside an area of the contact hole CH1.

FIG. 5G is a cross-sectional view illustrating a step of forming an insulating protection film by etching the insulating film 120 illustrated in FIG. 5F.

FIG. 5H is a cross-sectional view illustrating a step of removing the resist on the insulating protection film illustrated in FIG. 5G.

FIG. 5I is a cross-sectional view illustrating a step of forming a metal film on the insulating film 104 and the insulating protection film illustrated in FIG. 5H.

FIG. 5J is a cross-sectional view illustrating a step of forming a lower electrode b patterning the metal film illustrated in FIG. 5I.

FIG. 5K is a cross-sectional view illustrating a step of forming an n-type amorphous semiconductor layer, an intrinsic amorphous semiconductor layer, and a p-type amorphous semiconductor layer on the lower electrode and the insulating protection film illustrated in FIG. 5J, and forming a transparent conductive film on the p-type amorphous semiconductor layer.

FIG. 5L is a cross-sectional view illustrating a step of forming an upper electrode by patterning the transparent conductive film illustrated in FIG. 5K.

FIG. 5M is a cross-sectional view illustrating a step of forming a photoelectric conversion layer by patterning the n-type amorphous semiconductor layer, the intrinsic amorphous semiconductor layer, and the p-type amorphous semiconductor layer illustrated in FIG. 5K.

FIG. 5N is a cross-sectional view illustrating a step of forming an insulating film 105 on the upper electrode illustrated in FIG. 5M.

FIG. 5O is a cross-sectional view illustrating a step of forming a contact hole CH2 in the insulating film 105 illustrated in FIG. 5N.

FIG. 5P is a cross-sectional view illustrating a step of forming an insulating film 106 on the insulating film 105 illustrated in FIG. 5O.

FIG. 5Q is a cross-sectional view illustrating a step of forming an opening in the insulating film 106 illustrated in FIG. 5P.

FIG. 5R is a cross-sectional view illustrating a step of forming a metal film on the insulating film 106 illustrated in FIG. 5Q.

FIG. 5S is a cross-sectional view illustrating a step of forming a bias line by patterning the metal film illustrated in FIG. 5R.

FIG. 5T is a cross-sectional view illustrating a step of forming a transparent conductive film 220 so that the transparent conductive film 220 covers the bias line illustrated in FIG. 5S.

FIG. 5U is a cross-sectional view illustrating a step of forming a transparent conductive film 17 by patterning the transparent conductive film 220 illustrated in FIG. 5T.

FIG. 5V is a cross-sectional view illustrating a step of forming an insulating film 107 so that the insulating film 107 covers the transparent conductive film 17 illustrated in FIG. 5U.

FIG. 5W is a cross-sectional view illustrating a step of forming an insulating film 108 on the insulating film 107 illustrated in FIG. 5V.

FIG. 6 is a cross-sectional view of an imaging panel of Embodiment 2.

FIG. 7A explains a process of producing the imaging panel illustrated in FIG. 6; FIG. 7A is a cross-sectional view illustrating a step of forming a resist used for forming an insulating protection film, on an insulating film 120.

FIG. 7B is a cross-sectional view illustrating a step of forming an insulating protection film by etching the insulating film 120 illustrated in FIG. 7A.

FIG. 7C is a cross-sectional view illustrating a step of forming an n-type amorphous semiconductor layer, an intrinsic amorphous semiconductor layer, and a p-type amorphous semiconductor layer on the lower electrode and the insulating protection film illustrated in FIG. 7B, and forming a transparent conductive film on the p-type amorphous semiconductor layer.

FIG. 7D is a cross-sectional view illustrating a step of forming a photoelectric conversion layer by patterning the n-type amorphous semiconductor layer, the intrinsic amorphous semiconductor layer, and the p-type amorphous semiconductor layer illustrated in FIG. 7C.

FIG. 8 is a cross-sectional view of an imaging panel that includes an insulating protection film having an end whose shape is different from the end of the insulating protection film illustrated in FIG. 6.

FIG. 9 is a cross-sectional view illustrating an exemplary conventional imaging panel.

### MODE FOR CARRYING OUT THE INVENTION

An imaging panel according to one embodiment of the present invention is an imaging panel that generates an image based on scintillation light that is obtained from X-rays transmitted through an object, and the imaging panel includes: a substrate; a thin film transistor that is formed on the substrate; an insulating resin film that is provided on the thin film transistor and has an opening on a drain electrode of the thin film transistor; an insulating protection film that is arranged on an outer side with respect to the opening on the insulating resin film so as to be separated from the opening; a lower electrode that is provided on the insulating resin film, overlaps with a part of the insulating protection film, and is connected with the drain electrode at the opening; a photoelectric conversion layer that is provided on the lower electrode, and converts the scintillation light into charges; and an upper electrode that is provided on the photoelectric conversion layer (the first configuration).

According to the first configuration, the insulating protection film is provided on the insulating resin film, on an outer side with respect to the opening of the insulating resin film, and the lower electrode is provided on the insulating resin film, in an area including the opening. The photoelectric conversion layer is provided on the lower electrode, and the upper electrode is provided on the photoelectric conversion layer. The insulating protection film, therefore, is not formed in the opening of the insulating resin film, and in the opening, the lower electrode is appropriately covered with the photoelectric conversion layer, which results in that it is unlikely that off-leakage current would be generated. Further, since the insulating resin film is covered with at least either the insulating protection film or the lower electrode, it is unlikely that carbon gas would be generated even in a case where the photoelectric conversion layer is formed at a temperature equal to or higher than the heat-resistant temperature of the insulating resin film, which results in that excellent diode properties can be achieved.

The first configuration may be characterized in that a part of the photoelectric conversion layer overlaps with the lower electrode and the insulating protection film when viewed in a plan view, and an opening-side end of the insulating protection film has a tapered shape (the second configuration).

According to the second configuration, the opening-side end of the insulating protection film has a tapered shape. As compared with a case where the opening-side end of the insulating protection film does not have a tapered shape, therefore, the lower electrode and the photoelectric conversion layer are not discontinuous to each other in the vicinity of the end of the insulating protection film. This makes it possible to appropriately cover the lower electrode with the photoelectric conversion layer, thereby suppressing off-leakage current.

The first configuration may be characterized in that the photoelectric conversion layer overlaps with the lower electrode and does not overlap with the insulating protection film when viewed in a plan view (the third configuration).

According to the third configuration, the photoelectric conversion layer does not overlap with the insulating protection film, which allows the lower electrode to be appropriately covered with the photoelectric conversion layer irrespective of the shape of the end of the insulating protection film, thereby suppressing off-leakage current.

The third configuration may be characterized in that an opening-side end of the insulating protection film has a tapered shape (the fourth configuration).

With the fourth configuration, the end of the insulating protection film can be covered with the lower electrode more easily, as compared with a case where the end of the insulating protection film does not have a tapered shape.

A method for producing an imaging panel according to one embodiment of the present invention is a method for producing an imaging panel that generates an image based on scintillation light that is obtained from X-rays transmitted through an object, and the producing method includes the steps of forming a thin film transistor on a substrate; forming an insulating resin film on the thin film transistor, the insulating resin film having an opening at a position that overlaps with a drain electrode of the thin film transistor; forming an inorganic insulating film on the insulating resin film; applying a resist on the inorganic insulating film, and patterning the resist so that the resist is arranged on an outer side with respect to the opening so as to be separated from the opening, and ends of the resist have tapered shapes; forming an insulating protection film outside the opening by etching the inorganic insulating film by using the resist as a mask; forming, on the insulating resin film, a first transparent electrode film as a lower electrode that overlaps with a part of the insulating protection film and is connected with the drain electrode through the opening; forming a first semiconductor layer of a first conductive type, an intrinsic amorphous semiconductor layer, and a second semiconductor layer of a second conductive type that is opposite to the first conductive type, in the stated order, as a photoelectric conversion layer on the insulating protection film and the first transparent electrode film; forming an upper electrode on the second semiconductor layer; applying a resist on the upper electrode, and etching the first semiconductor layer, the intrinsic amorphous semiconductor layer, and the second semiconductor layer, thereby forming the photoelectric conversion layer; removing the resist, and forming a first insulating film that covers the upper electrode; forming a contact hole on the upper electrode so that the contact hole passes through the first insulating film; forming a second insulating film on the first insulating film except for a portion thereof of the contact hole; forming a signal line for supplying a bias voltage, on the second insulating film; forming a transparent conductive film that connects the signal line and the upper electrode with each other through the contact hole, on the second insulating film; and forming a third insulating film that covers the transparent conductive film (the fifth configuration).

According to the fifth configuration, on the insulating resin film, the insulating protection film is arranged on an outer side with respect to the opening of the insulating resin film so as to be separated from the opening. Further, on the insulating resin film, the lower electrode connected with the drain electrode in the opening of the insulating resin film is formed. Since the insulating protection film is arranged on an outer side with respect to the opening of the insulating resin film by using the resist having the end in a tapered shape, the end of the insulating protection film has a tapered shape. As compared with a case where the end of the insulating protection film is not in a tapered shape, therefore, it is more unlikely that the lower electrode and the photoelectric conversion layer would be formed so as to be discontinuous in the vicinity of the end of the insulating protection film, whereby the lower electrode can be appropriately covered with the photoelectric conversion layer. As a result, an imaging panel in which off-leakage current is suppressed can be provided. Further, since the insulating resin film is covered with at least either the insulating protection film and the lower electrode, the photoelectric conversion layer can be formed at a temperature equal to or higher than the heat-resistant temperature of the insulating resin film.

The following description describes embodiments of the present invention in detail while referring to the drawings. Identical or equivalent parts in the drawings are denoted by the same reference numerals and descriptions of the same are not repeated.

### Embodiment 1

### Configuration

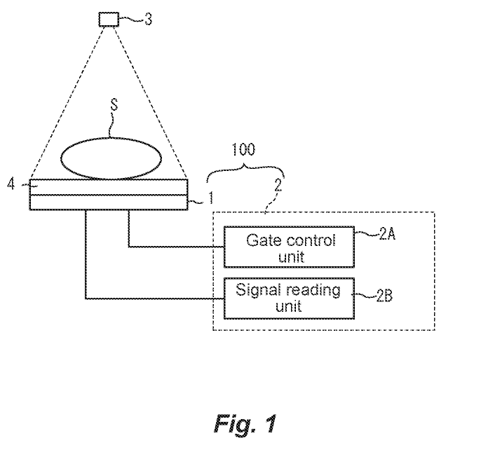

FIG. 1 is a schematic diagram illustrating an X-ray imaging device in the present embodiment. The X-ray imaging device 100 includes an imaging panel 1 and a control unit 2. The control unit 2 includes a gate control unit 2A and a signal reading unit 2B. X-rays are projected from the X-ray source 3 to an object S, and X-rays transmitted through the object S are converted into fluorescence (hereinafter referred to as scintillation light) by a scintillator 4 provided above the imaging panel 1. The X-ray imaging device 100 acquires an X-ray image by picking up the scintillation light with the imaging panel 1 and the control unit 2.

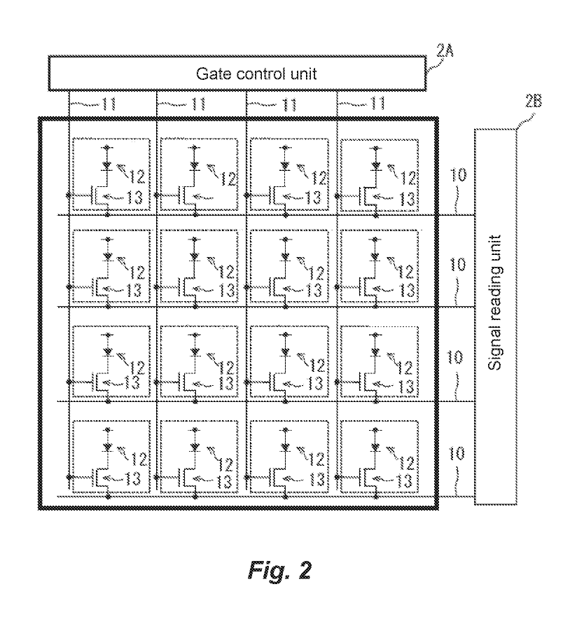

FIG. 2 is a schematic diagram illustrating a schematic configuration of the imaging panel 1. As illustrated in FIG. 2, a plurality of source lines 10, and a plurality of gate lines 11 intersecting with the source lines 10 are formed in the imaging panel 1. The gate lines 11 are connected with the gate control unit 2A, and the source lines 10 are connected with the signal reading unit 2B.

The imaging panel 1 includes TFTs 13 connected to the source lines 10 and the gate lines 11, at positions at which the source lines 10 and the gate lines 11 intersect. Further, photodiodes 12 are provided in areas surrounded by the source lines 10 and the gate lines 11 (hereinafter referred to as pixels). In each pixel, scintillation light obtained by converting X-rays transmitted through the object S is converted by the photodiode 12 into charges according to the amount of the light.

The gate lines 11 in the imaging panel 1 are sequentially switched by the gate control unit 2A into a selected state, and the TFT 13 connected to the gate line 11 in the selected state is turned ON. When the TFT 13 is turned ON, a signal according to the charges obtained by the conversion by the photodiode 12 is output through the source line 10 to the signal reading unit 2B.

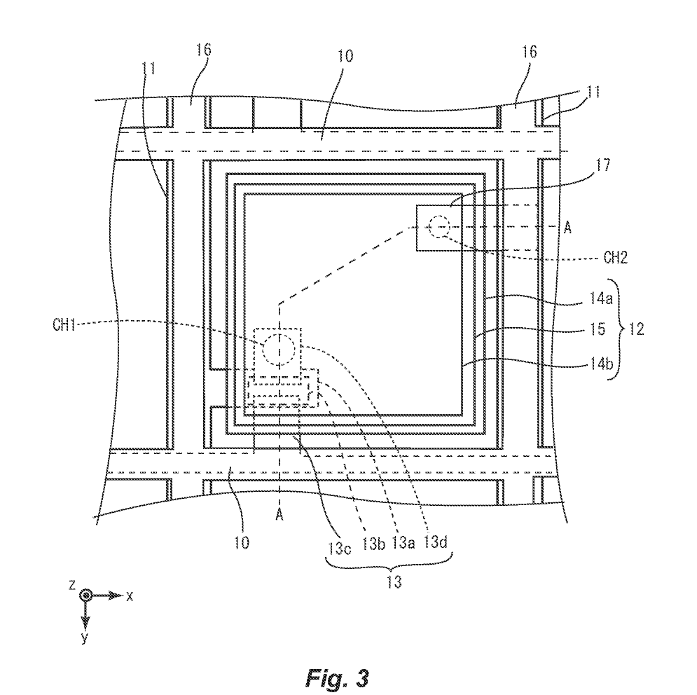

FIG. 3 is an enlarged plan view of one pixel portion of the imaging panel 1 illustrated in FIG. 2. As illustrated in FIG. 3, in the pixel surrounded by the gate lines 11 and the source lines 10, a lower electrode 14a a photoelectric conversion layer 15, and an upper electrode 14b that compose the photodiode 12 are arranged so as to overlap with one another. Further, a bias line 16 is arranged so as to overlap with the gate line 11 and the source line 10 when viewed in a plan view. The bias line 16 supplies a bias voltage to the photodiode 12. The TFT 13 includes a gate electrode 13a integrated with the gate line 11, a semiconductor activity layer 13b, a source electrode 13c integrated with the source line 10, and a drain electrode 13d. In the pixel, a contact hole CH1 for connecting the drain electrode 13d and the lower electrode 14a with each other is provided. Further, in the pixel, a transparent conductive film 17 is provided so as to overlap with the bias line 16, and a contact hole CH2 for connecting the transparent conductive film 17 and the upper electrode 14b with each other is provided.

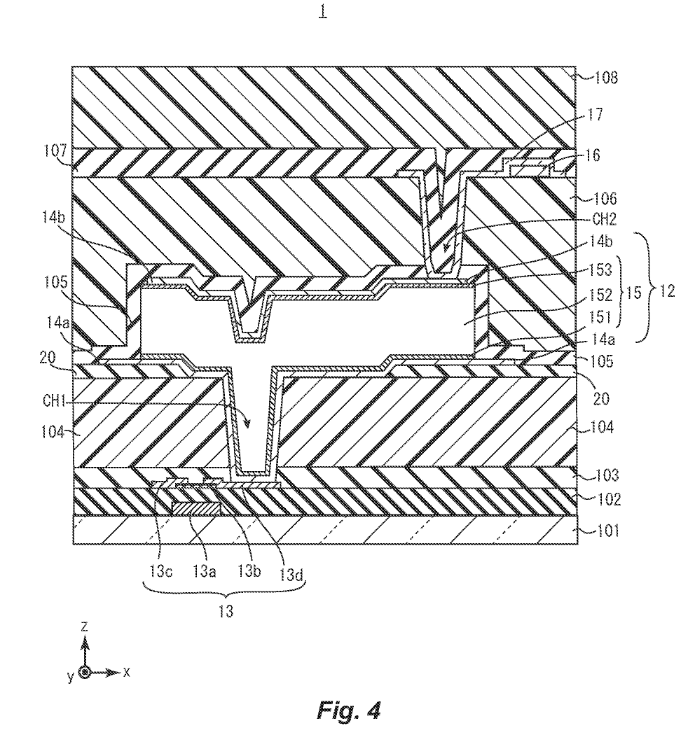

Here, FIG. 4 illustrates a cross-sectional view of the pixel illustrated in FIG. 3 taken along line A-A. As illustrated in FIG. 4, the TFT 13 is formed on the substrate 101. The substrate 101 is a substrate having insulating properties, such as a glass substrate, a silicon substrate, a plastic substrate having heat-resisting properties, or a resin substrate.

On the substrate 101, the gate electrode 13a integrated with the gate line 11 is formed. The gate electrode 13a and the gate line 11 are made of, for example, a metal such as aluminum (Al), tungsten (W), molybdenum (Mo), molybdenum nitride (MoN), tantalum (Ta), chromium (Cr), titanium (Ti), or copper (Cu), an alloy of any of these metals, or a metal nitride of these metals. In the present embodiment, the gate electrode 13a and the gate line 11 have a laminate structure in which a metal film made of molybdenum nitride and a metal film made of aluminum are laminated in this order. Regarding thicknesses of these metal films, for example, the metal film made of molybdenum nitride has a thickness of 100 nm, and the metal film made of aluminum has a thickness of 300 nm.

The gate insulating film 102 is formed on the substrate 101, and covers the gate electrode 13a. The gate insulating film 102 may be formed with, for example, silicon oxide (SiOₓ), silicon nitride (SiNₓ), silicon oxide nitride (SiOₓN_{y})(x>y), or silicon nitride oxide (SiNₓO_{y})(x>y). In the present embodiment, the gate insulating film 102 is formed with a laminate film obtained by laminating silicon oxide (SiOₓ) and silicon nitride (SiNₓ) in the order, and regarding the thicknesses of these films, the film of silicon oxide (SiOₓ) has a thickness of 50 nm, and the film of silicon nitride (SiNₓ) has a thickness of 400 nm.

The semiconductor activity layer 13b, as well as the source electrode 13c and the drain electrode 13d connected with the semiconductor activity layer 13b are formed on the gate electrode 13a with the gate insulating film 102 being interposed therebetween.

The semiconductor activity layer 13b is formed in contact with the gate insulating film 102. The semiconductor activity layer 13b is made of an oxide semiconductor. For forming the oxide semiconductor, for example, the following material may be used: InGaO₃(ZnO)₅; magnesium zinc oxide (MgₓZn₁₋ₓO); cadmium zinc oxide (CdₓZn₁₋ₓO), cadmium oxide (CdO); or an amorphous oxide semiconductor containing indium (In), gallium (Ga), and zinc (Zn) at a predetermined ratio. In the present embodiment, the semiconductor activity layer 13b is made of an amorphous oxide semiconductor containing indium (In), gallium (Ga), and zinc (Zn) at a predetermined ratio, and has a thickness of, for example, 70 nm.

The source electrode 13c and the drain electrode 13d are formed in contact with the semiconductor activity layer 13b and the gate insulating film 102. The source electrode 13c is integrated with the source line 10. The drain electrode 13d is connected with the lower electrode 14a through the contact hole CH1.

The source electrode 13c and the drain electrode 13d are formed in the same layer, and are made of, for example, a metal such as aluminum (Al), tungsten (W), molybdenum (Mo), molybdenum nitride (MoN), tantalum (Ta), chromium (Cr), titanium (Ti), or copper (Cu), or alternatively, an alloy of any of these, or a metal nitride of any of these. Further, as the material for the source electrode 13c and the drain electrode 13d, the following material may be used: a material having translucency such as indium tin oxide (ITO), indium zinc oxide (IZO), indium tin oxide (ITSO) containing silicon oxide, indium oxide (In₂O₃), tin oxide (SnO₂), zinc oxide (ZnO), or titanium nitride; or a material obtained by appropriately combining any of these.

The source electrode 13c and the drain electrode 13d may be, for example, a laminate of a plurality of metal films. More specifically, the source electrode 13c, the source line 10, and the drain electrode 13d have a laminate structure in which a metal film made of molybdenum nitride (MoN), a metal film made of aluminum (Al), and a metal film made of molybdenum nitride (MoN) are laminated in this order. Regarding the thicknesses of the films, the metal film in the lower layer, which is made of molybdenum nitride (MoN), has a thickness of 100 nm, the metal film made of aluminum (Al) has a thickness of 500 nm, and the metal film in the upper layer, which is made of molybdenum nitride (MoN), has a thickness of 50 nm.

An insulating film 103 is provided so as to cover the source electrode 13c and the drain electrode 13d. The insulating film 103 may have a single layer structure made of silicon oxide (SiO₂) or silicon nitride (SiN), or a laminate structure obtained by laminating silicon nitride (SiN) and silicon oxide (SiO₂) in this order.

On the insulating film 103, an insulating film 104 (insulating resin film) is formed. The insulating film 104 is made of an organic transparent resin, for example, acrylic resin or siloxane-based resin, and has a thickness of, for example, 2.5 μm.

On the drain electrode 13d, the contact hole CH1 is formed, which passes through the insulating film 104 and the insulating film 103.

On the insulating film 104, in an area thereof excluding the contact hole CH1, an insulating protection film 20 is formed. The insulating protection film 20 is formed with an inorganic insulating film made of, for example, silicon nitride (SiN), and has a thickness of, for example, 200 nm. The insulating protection film 20 has a taper-shaped end on the contact hole CH1 side.

On the insulating film 104, the lower electrode 14a, which partially overlaps with the insulating protection film 20 and is connected with the drain electrode 13d through the contact hole CH1, is formed. The lower electrode 14a is formed with, for example, a metal film containing molybdenum nitride (MoN), and has a thickness of, for example, 200 nm.

On the lower electrode 14a, the photoelectric conversion layer 15 is formed. The photoelectric conversion layer 15 overlaps with the lower electrode 14a, and at the same time, partially overlaps with the insulating protection film 20. The photoelectric conversion layer 15 is composed of the n-type amorphous semiconductor layer 151, the intrinsic amorphous semiconductor layer 152, and the p-type amorphous semiconductor layer 153, which are laminated in the order.

The n-type amorphous semiconductor layer 151 is made of amorphous silicon doped with an n-type impurity for example, phosphorus). The n-type amorphous semiconductor layer 151 has a thickness of, for example, 30 nm.

The intrinsic amorphous semiconductor layer 152 is made of intrinsic amorphous silicon. The intrinsic amorphous semiconductor layer 152 is formed in contact with the n-type amorphous semiconductor layer 151. The intrinsic amorphous semiconductor layer has a thickness of, for example, 1000 nm.

The p-type amorphous semiconductor layer 153 is made of amorphous silicon doped with a p-type impurity (for example, boron). The p-type amorphous semiconductor layer 153 is formed in contact with the intrinsic amorphous semiconductor layer 152. The p-type amorphous semiconductor layer 153 has a thickness of, for example, 5 nm.

On the p-type amorphous semiconductor layer 153, the upper electrode 14b is formed. The upper electrode 14b is made of for example, indium tin oxide (ITO), and has a thickness of, for example, 70 nm.

An insulating film 105 is formed on the insulating protection film 20 and the lower electrode 14a so as to cover the photodiode 12. The insulating film 105 is, for example, an inorganic insulating film made of silicon nitride (SiN), and has a thickness of, for example, 300 nm.

In the insulating film 105, a contact hole CH2 is formed at a position that overlaps with the upper electrode 14b.

On the insulating film 105, in an area thereof except for the contact hole CH2, an insulating film 106 is formed. The insulating film 106 is formed with an organic transparent resin made of, for example, acrylic resin or siloxane-based resin, and has a thickness of, for example, 2.5 μm.

On the insulating film 106, the bias line 16 is formed. Further, on the insulating film 106, the transparent conductive film 17 is formed so as to overlap with the bias line 16. The transparent conductive film 17 is in contact with the upper electrode 14b at the contact hole CH2. The bias line 16 is connected to the control unit 2 (see FIG. 1). The bias line 16 applies a bias voltage through the contact hole CH2 to the upper electrode 14b, the bias voltage being input from the control unit 2. The bias line 16 has a laminate structure that is obtained by laminating, for example, a metal film made of molybdenum nitride (MoN), a metal film made of aluminum (Al), and a metal film made of titanium (Ti) in this order. The films of molybdenum nitride (MoN), aluminum (Al), and titanium (Ti) have thicknesses of, for example, 100 nm, 300 nm, and 50 nm, respectively.

On the insulating film 106, an insulating film 107 is formed so as to cover the transparent conductive film 17. The insulating film 107 is an inorganic insulating film made of, for example, silicon nitride (SiN), and has a thickness of, for example, 200 nm.

On the insulating film 107, an insulating film 108 is formed. The insulating film 108 is made of, for example, an organic transparent resin such as acrylic resin or siloxane-based resin, and has a thickness of, for example, 2.0 μm.

### Method for Producing Imaging Panel 1

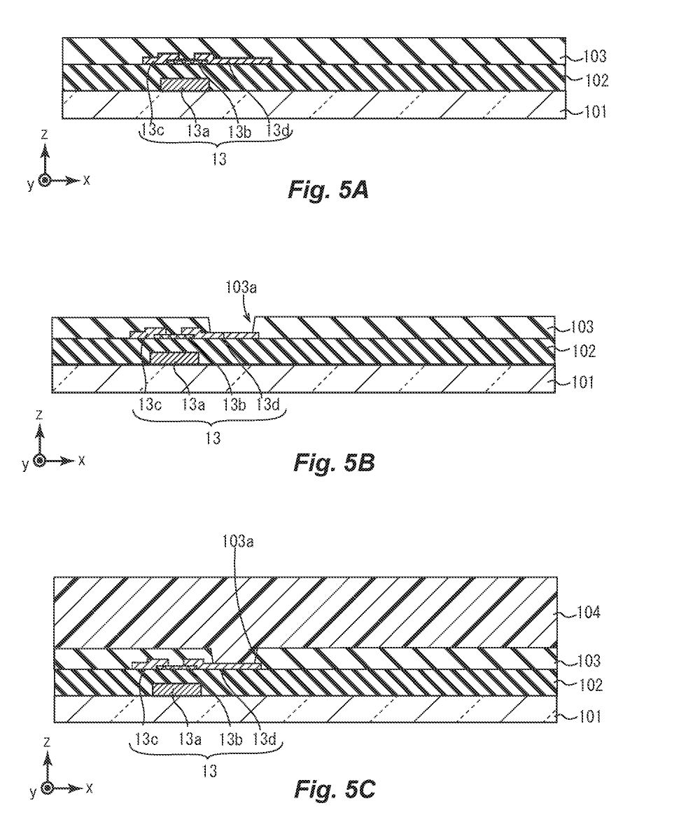

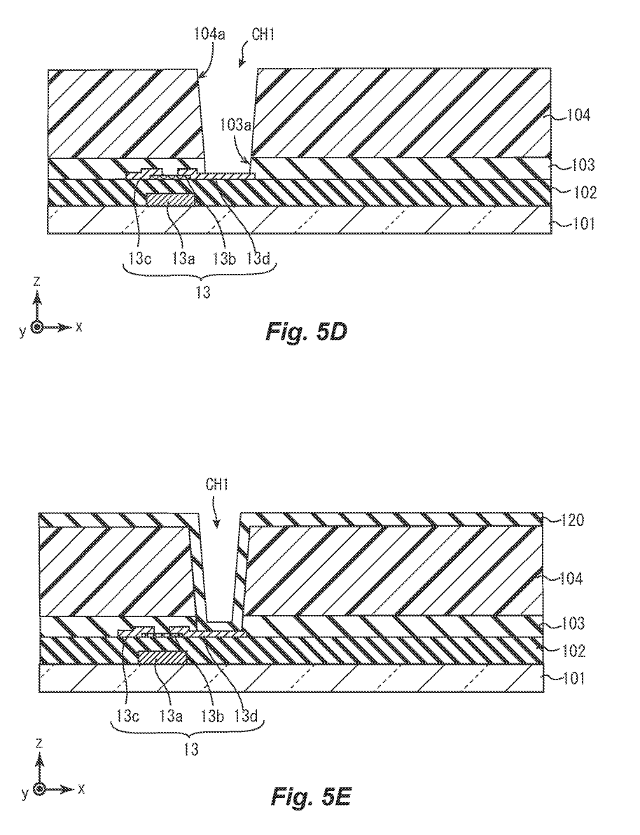

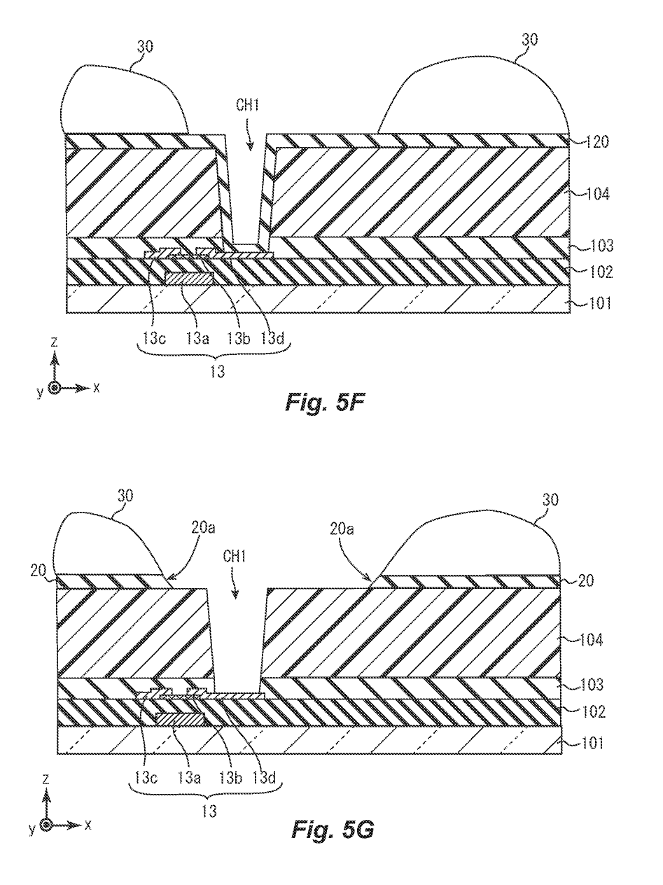

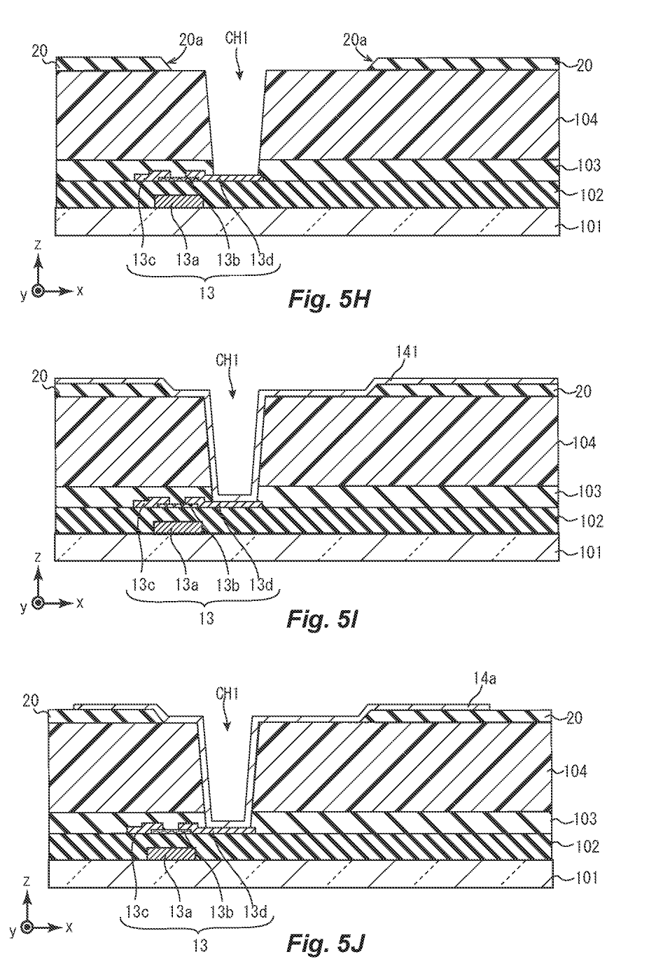

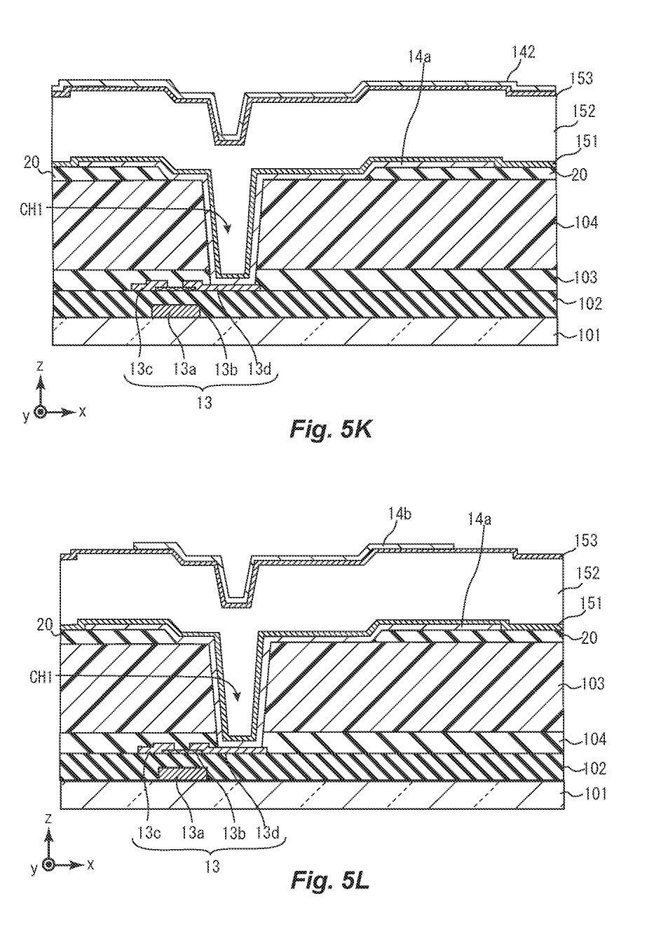

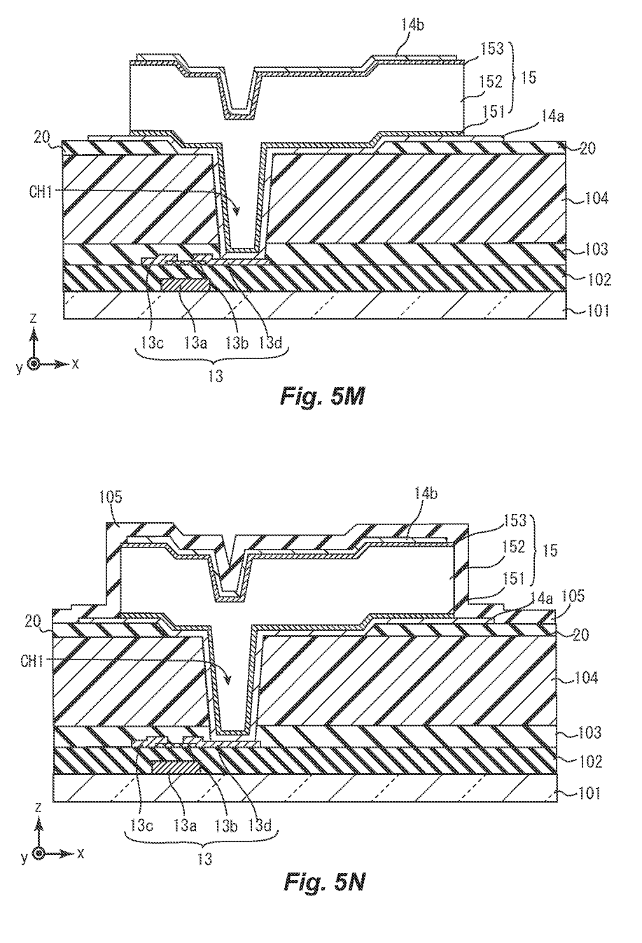

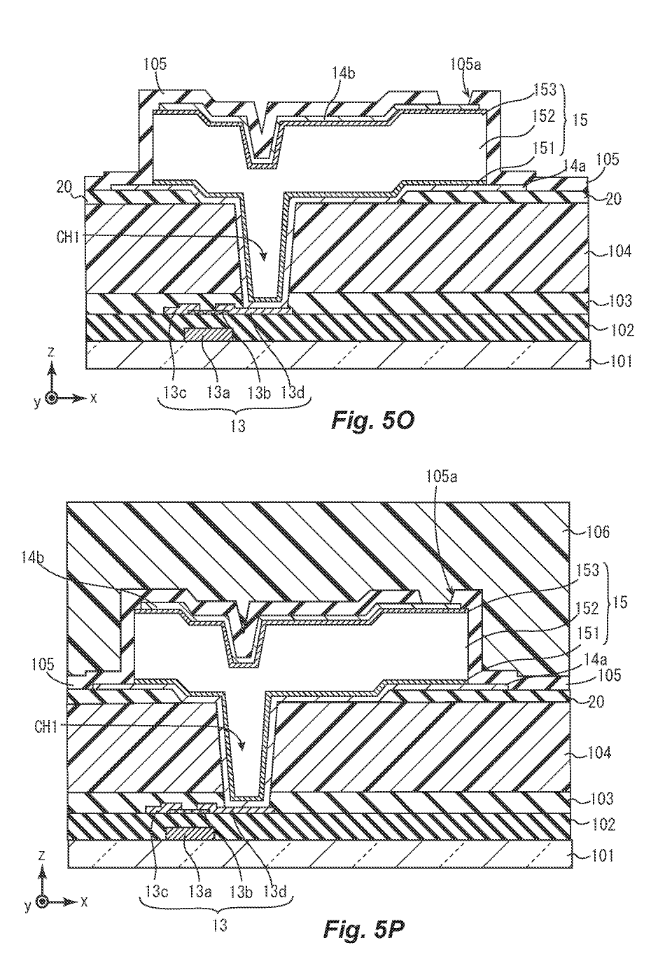

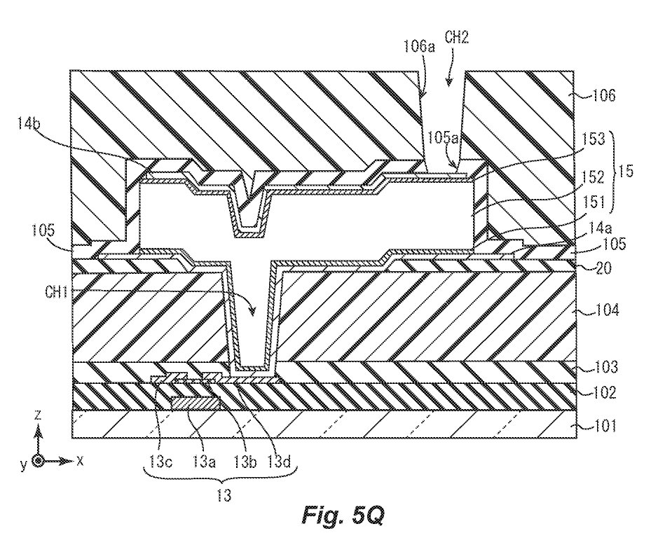

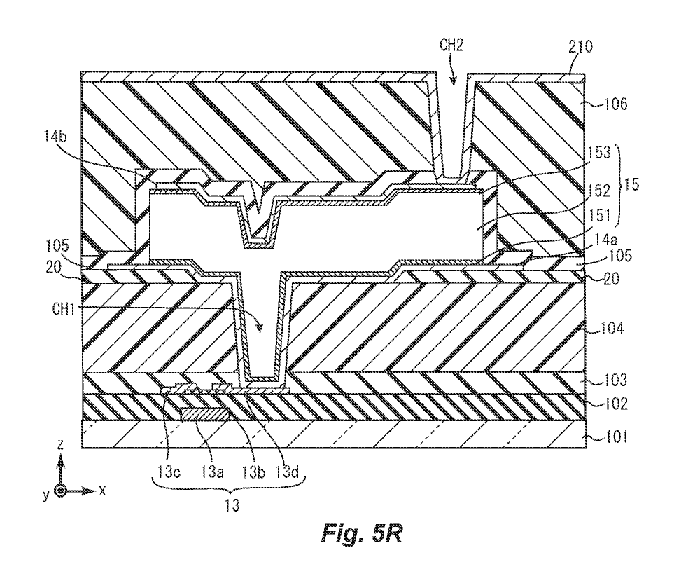

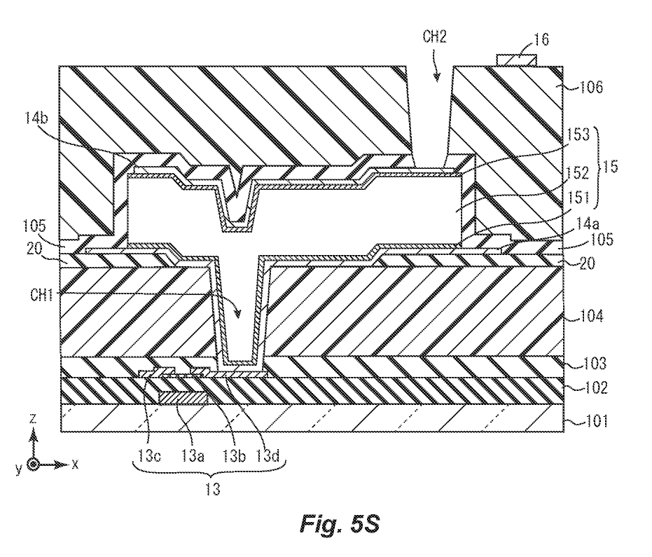

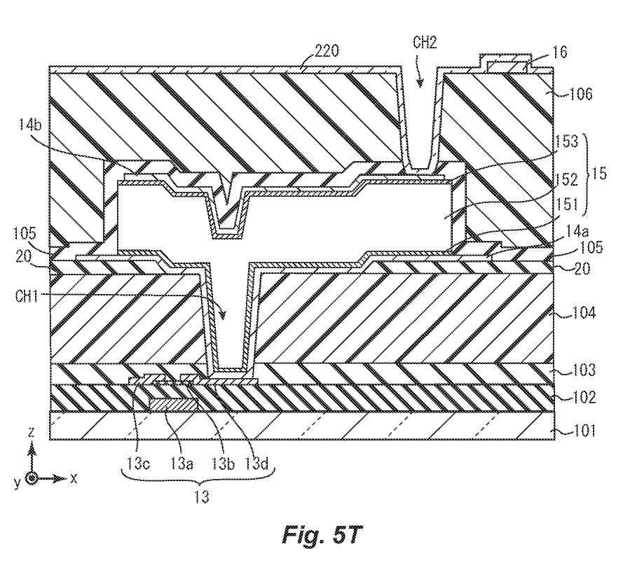

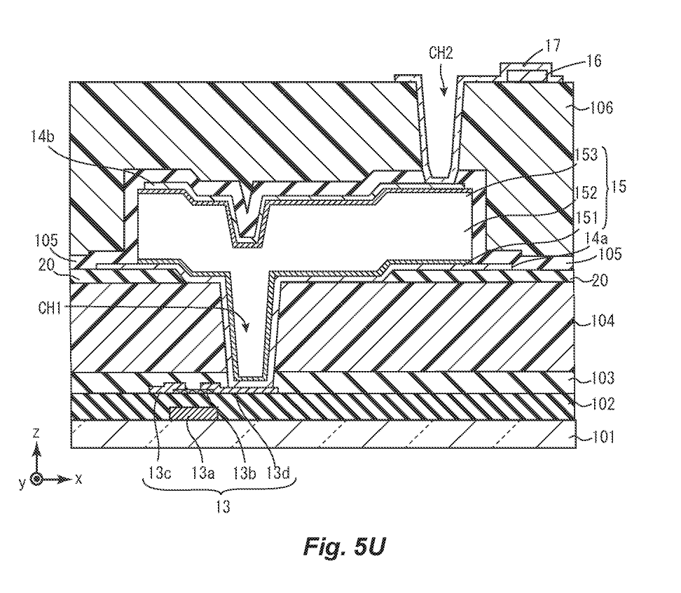

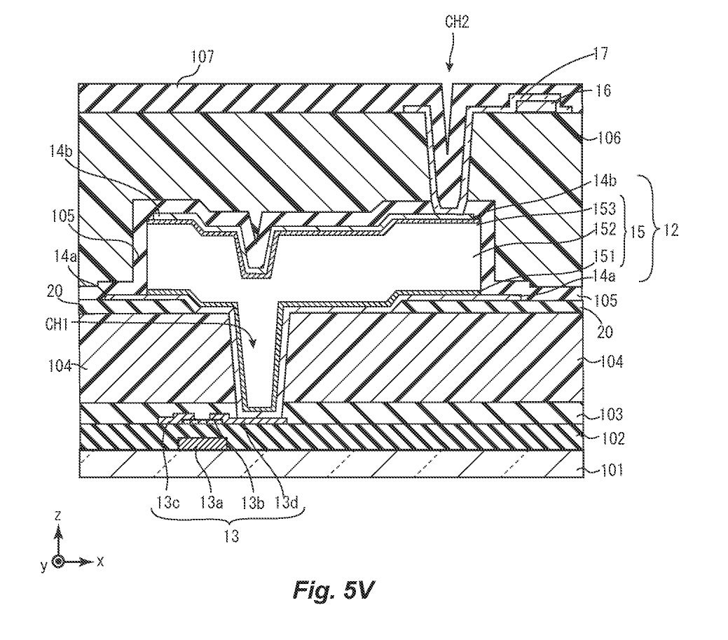

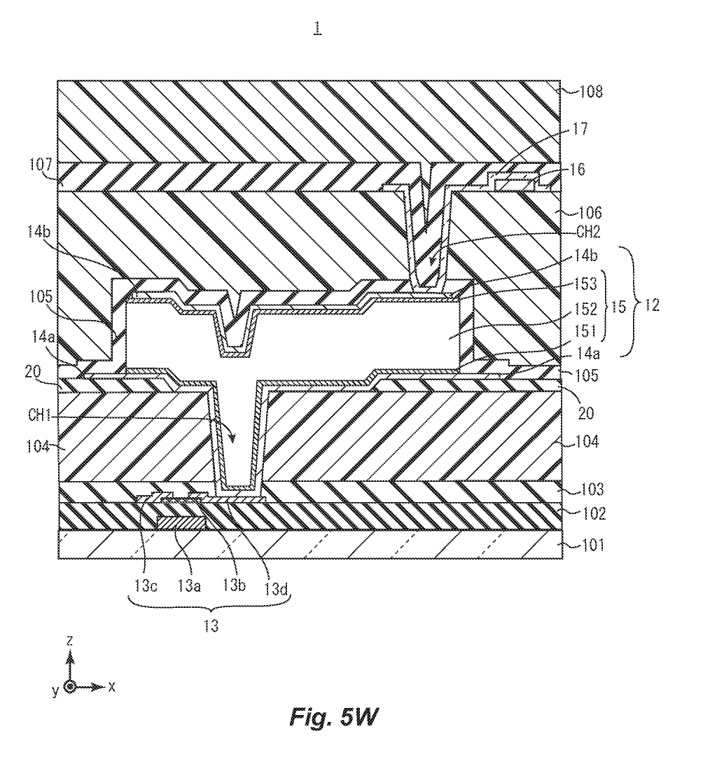

Next, the following description describes a method for producing the imaging panel 1. FIGS. 5A to 5W are cross-sectional views of the pixel taken along line A-A in respective steps of the method for producing the imaging panel 1 (see FIG. 3).

As illustrated in FIG. 5A, the gate insulating film 102 and the TFT 13 are formed on the substrate 101 by a known method, and the insulating film 103 made of silicon nitride (SiN) is formed by, for example, plasma CVD, so as to cover the TFT 13.

Subsequently, a heat treatment at about 350° C. is applied to an entire surface of the substrate 101, and photolithography and wet etching are carried out so that the insulating film 103 is patterned, whereby an opening 103a is formed on the drain electrode 13d (see FIG. 5B).

Next, the insulating film 104 made of acrylic resin or siloxane-based resin is formed on the insulating film 103 by, for example, slit coating (see FIG. 5C).

Then, an opening 104a of the insulating film 104 is formed by photolithography, whereby the contact hole CH1 is formed (see FIG. 5D).

Subsequently, on the insulating film 104, for example, the insulating film 120 made of silicon nitride (SiN) is formed by plasma CVD (see FIG. 5E).

Thereafter, a resist is applied on the insulating film 120, and the resist is patterned. Through these steps, the resist 30 is formed in an area outside the contact hole CH1 (see FIG. 5F). Here, an end on the contact hole CH1 side of the resist 30 has a tapered shape, and the angle of the tapered shape is 70° or smaller with respect to the insulating film 120.

Subsequently, using the resist 30 as a mask, the insulating film 120 is dry-etched. Here, the end on the contact hole CH1 side of the resist 30 is also etched. Through these steps, the insulating protection film 20 is formed on the outside with respect to the contact hole CH1, whereby an opening 20a of the insulating protection film 20 is formed. The opening 20a of the insulating protection film 20 has a tapered shape similar to that of the end on the contact hole CH1 side of the resist 30, and the angle of the tapered shape is 70° or smaller (see FIG. 5G).

Thereafter, the resist 30 on the insulating protection film 20 is removed (see FIG. 5H), and a metal film 141 made of molybdenum nitride (MoN) is formed on the insulating film 104 so as to cover the insulating protection film 20 by, for example, sputtering (see FIG. 5I).

Then, photolithography and wet etching are carried out, whereby the metal film 141 is patterned. Through these steps, the lower electrode 14a is formed, which partially overlaps with the insulating protection film 20, and is connected with the drain electrode 13d through the contact hole CH1 (see FIG. 5J).

Next, the n-type amorphous semiconductor layer 151, the intrinsic amorphous semiconductor layer 152, and the p-type amorphous semiconductor layer 153 are formed on the insulating protection film 20 so as to cover the lower electrode 14a by, for example, plasma CVD. Then, on the p-type amorphous semiconductor layer 153, for example, the transparent conductive film 142 made of ITO is formed (see FIG. 5K). At least either the lower electrode 14a or the insulating protection film 20 is formed in a lower layer in the area where the n-type amorphous semiconductor layer 151, the intrinsic amorphous semiconductor layer 152, and the p-type amorphous semiconductor layer 153 are formed, in other words, the insulating film 104 in the area where the n-type amorphous semiconductor layer 151 is formed is covered with at least either the lower electrode 14a and the insulating protection film 20. This makes it unlikely that carbon gas would be generated from the insulating film 104, even if the n-type amorphous semiconductor layer 151 is formed. by plasma CVD at a temperature equal to or higher than the heat-resistant temperature of the insulating film 104.

Thereafter, photolithography and dry etching are carried out so that the transparent conductive film 142 is patterned, whereby the upper electrode 14b is formed on the p-type amorphous semiconductor layer 153 (see FIG. 5L).

Subsequently, a resist is applied on the p-type amorphous semiconductor layer 153 so as to cover the upper electrode 14b, and the n-type amorphous semiconductor layer 151, the intrinsic amorphous semiconductor layer 152, and the p-type amorphous semiconductor layer 153 are patterned. Through these steps, the photoelectric conversion layer 15 is formed on the lower electrode 14a (see FIG. 5M). The photoelectric conversion layer 15 has a width that is greater than the width in the X-axis direction of the opening 20a in the insulating protection film 20, and that is smaller than the width in the X-axis direction of the lower electrode 14a.

Next, the resist is removed, and the insulating film 105 made of silicon nitride (SiN) is formed by, for example, plasma CVD, so as to cover the insulating protection film 20, the lower electrode Ha, the photoelectric conversion layer 15, and the upper electrode 14b (see FIG. 5N).

Then, photolithography and wet etching are carried out, whereby an opening 105a of the insulating film 105 is formed at a position that partially overlaps with the upper electrode 14b (see FIG. 5M).

Subsequently, the insulating film 106 is formed with acrylic resin or siloxane-based resin by, for example, slit-coating on the insulating film 105 (see FIG. 5P). Then, the insulating film 106 is patterned by photolithography. Through these steps, an opening 106a of the insulating film 106 is formed on the opening 105a, and the contact hole CH2 composed of the opening 105a and the opening 106a are formed (see FIG. 5Q).

Next, a metal film 210 obtained by laminating molybdenum nitride (MoN), aluminum (Al), and titanium (Ti) in this order is formed on the insulating film 106 by, for example, sputtering (see FIG. 5R).

Then, photolithography and wet etching are carried out so as to pattern the metal film 210, whereby the bias line 16 is formed (see FIG. 5R).

Subsequently, the transparent conductive film 220 made of ITO is formed on the insulating film 106 by, for example, sputtering so as to cover the bias line 16 (see FIG. 5T).

Then, photolithography and dry etching are carried out, whereby the transparent conductive film 220 is patterned, whereby the transparent conductive film 17 that is connected with the bias line 16 and is connected with the upper electrode 14b through the contact hole CH2 is formed (see FIG. 5U).

Next, on the insulating film 106, the insulating film 107 made of silicon nitride (SiN) is formed by, for example, plasma CVD so as to cover the transparent conductive film 17 (see FIG. 5V).

Subsequently, the insulating film 108 made of acrylic resin or siloxane-based resin is formed on the insulating film 107 by, for example, slit-coating, whereby the imaging panel 1 is formed (see FIG. 5W).

The method described above is the method for producing the imaging panel 1 in the present embodiment. In the present embodiment, on the insulating film 104 in an area where the n-type amorphous semiconductor layer 151 is formed, at least either the lower electrode 14a or the insulating protection film 20 is formed. Even if, therefore, the n-type amorphous semiconductor layer 151 is formed by plasma CVD under a high temperature, carbon gas is not generated from the insulating film 104.

Further, since the insulating protection film 20 is formed outside the contact hole CH1, only the lower electrode 14a is formed inside the contact hole CH1, whereas the insulating protection film 20 and the opening 20a of the insulating protection film 20 are not formed there. As compared with a case where the insulating protection film 20 and the opening 20a thereof are formed also inside the contact hole CH1, therefore, the n-type amorphous semiconductor layer 151 covering the lower electrode 14a can be appropriately formed in the contact hole CH1.

Further, the resist 30 (see FIG. 5F) used for forming the insulating protection film 20 is arranged on an outer side with respect to the contact hole CH1, the end on the contact hole CH1 side of the resist 30 is patterned in a tapered shape. As a result, the end on the opening side of the insulating protection film 20 is etched in a tapered shape (see FIG. 5F, G), which makes it unlikely that the lower electrode 14a and the n-type amorphous semiconductor layer 151 would be formed so as to be discontinuous at the end on the opening side of the insulating protection film 20. This allows the lower electrode 14a to be appropriately covered with the n-type amorphous semiconductor layer 151, thereby causing the lower electrode 14a and the intrinsic amorphous semiconductor layer 152 to be out of contact. This makes it possible to suppress off-leakage current.

### Operation of X-Ray Imaging Device 100

Here, operations of the X-ray imaging device 100 illustrated in FIG. 1 are described. First, X-rays are emitted from the X-ray source 3. Here, the control unit 2 applies a predetermined voltage (bias voltage) to the bias line 16 (see FIG. 3 and the like). X-rays emitted from the X-ray source 3 are transmitted through an object S, and are incident on the scintillator 4. The X-rays incident on the scintillator 4 are converted into fluorescence (scintillation light), and the scintillation light is incident on the imaging panel 1. When the scintillation light is incident on the photodiode 12 provided in each pixel in the imaging panel 1, the scintillation light is changed to charges by the photodiode 12 in accordance with the amount of the light. A signal according to the charges obtained by conversion by the photodiode 12 is read out through the source line 10 to the signal reading unit 2B (see FIG. 2 and the like) when the TFT 13 (see FIG. 3 and the like) is in the ON state according to a gate voltage (positive voltage) that is output from the gate control unit 2A through the gate line 11. Then, an X-ray image in accordance with the signal thus read out is generated in the control unit 2.

### Embodiment 2

Embodiment 1 is described above with reference to an exemplary case where a part of the photoelectric conversion layer 15 overlaps with the insulating protection film 20 when viewed in a plan view. The present embodiment is described herein with reference to an exemplary arrangement where the photoelectric conversion layer 15 does not overlap with the insulating protection film 20. The following description describes configurations different from those in Embodiment 1.

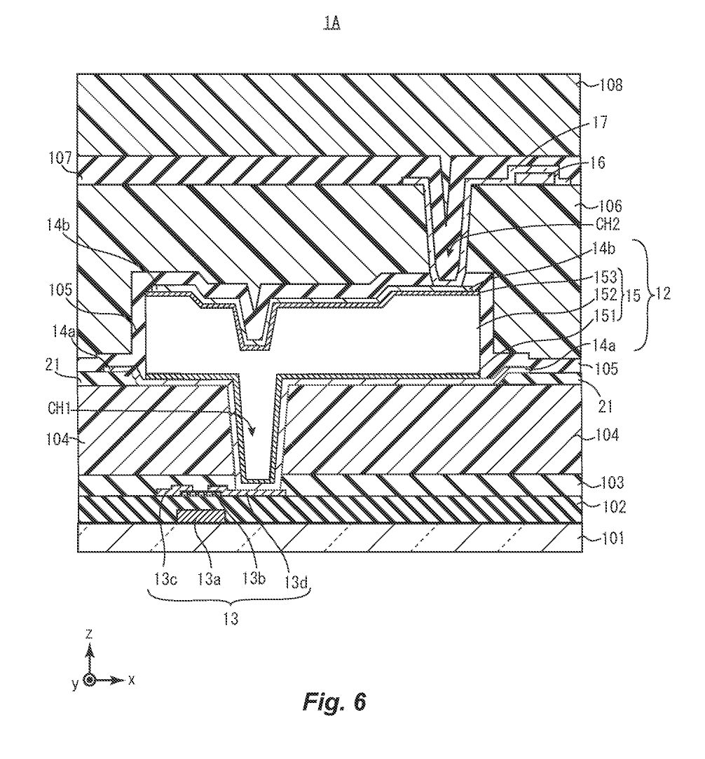

FIG. 6 is a cross-sectional view of a pixel of an imaging panel 1A in the present embodiment. As illustrated in FIG. 6, the imaging panel 1A includes an insulating protection film 21 on an insulating film 104. The end on the contact hole CH1 side of the insulating protection film 21 is covered with the lower electrode 14a, but since the insulating protection film 21 is arranged on an outer side with respect to the photoelectric conversion layer 15, the insulating protection film 21 does not overlap with the photoelectric conversion layer 15 when viewed in a plan view. The insulating film 104 is covered with at least either the lower electrode 14a or the insulating protection film 21.

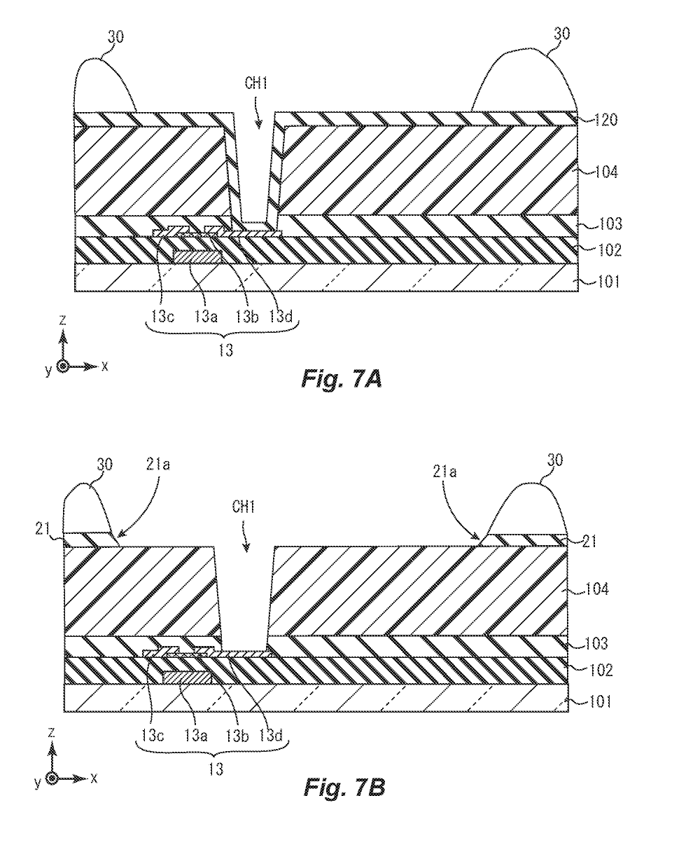

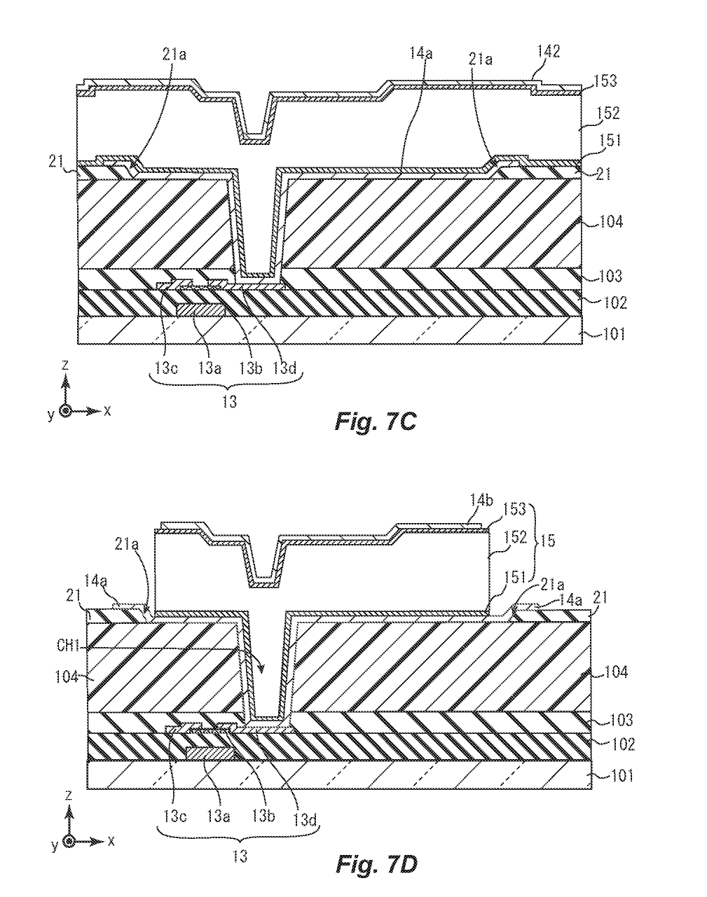

The method for producing the imaging panel 1A is different from that of Embodiment 1 in the following points. The steps illustrated in FIGS. 5A to SE are carried out in the same manner as in Embodiment 1, and thereafter, the resist is applied on the insulating film 120 (see FIG. 5E) and is patterned, so that a resist 30 is formed at a farther position on the outer side with respect to the contact hole CH1, as compared with that in Embodiment 1 (see FIG. 7A). Here, the end on the contact hole CH1 side of the resist 30 has a tapered shape identical to that in Embodiment 1.

Subsequently, using the resist 30 as a mask, the insulating film 120 is dried and etched. Through these steps, the end on the contact hole CH1 side of the resist 30 is also etched, the insulating protection film 21 is formed under the resist 30, and the opening 21a is formed in the insulating protection film 21. The opening 21a of the insulating protection film 21 has a tapered shape, which is similar to that of the end on the contact hole CH1 side of the resist 30 (see FIG. 7B).

Next, as is the case with Embodiment 1, the steps illustrated in FIGS. 5I and 5J are carried out, whereby a lower electrode 14a that overlaps with a part of the insulating protection film 20 and is connected with the drain electrode 13d through the contact hole CH1 is formed on the insulating film 104.

Then, the n-type amorphous semiconductor layer 151, the intrinsic amorphous semiconductor layer 152, and the p-type amorphous semiconductor layer 153 are formed in the stated order by plasma CVD so as to cover the lower electrode 14a and the insulating protection film 21, and thereafter, the transparent conductive film 142 made of ITO is formed on the p-type amorphous semiconductor layer 153 (see FIG. 7C). Since the insulating film 104 is covered with at least either the lower electrode 14a or the insulating protection film 21, the n-type amorphous semiconductor layer 151 can be formed at a temperature equal to or higher than the heat-resistant temperature of the insulating film 104.

Subsequently, the step illustrated in FIG. 5L is carried out so that the transparent conductive film 142 is patterned, whereby the upper electrode 14b is formed. Then, a resist is applied on the p-type amorphous semiconductor layer 153 so as to cover the upper electrode 14b, and the n-type amorphous semiconductor layer 151, the intrinsic amorphous semiconductor layer 152, and the p-type amorphous semiconductor layer 153 are patterned. Through these steps, on an inner wide with respect to the opening 21a of the insulating protection film 21, the photoelectric conversion layer 15 is formed (see FIG. 7D).

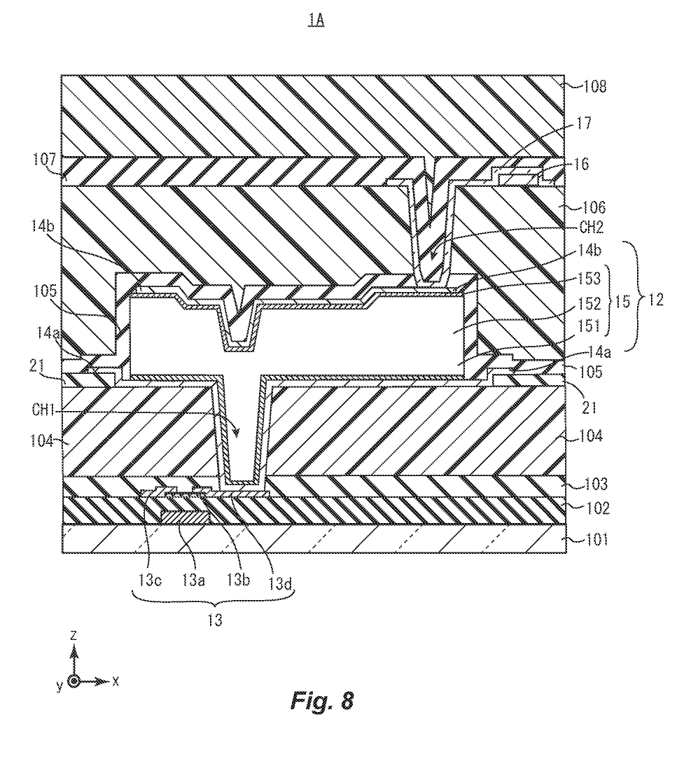

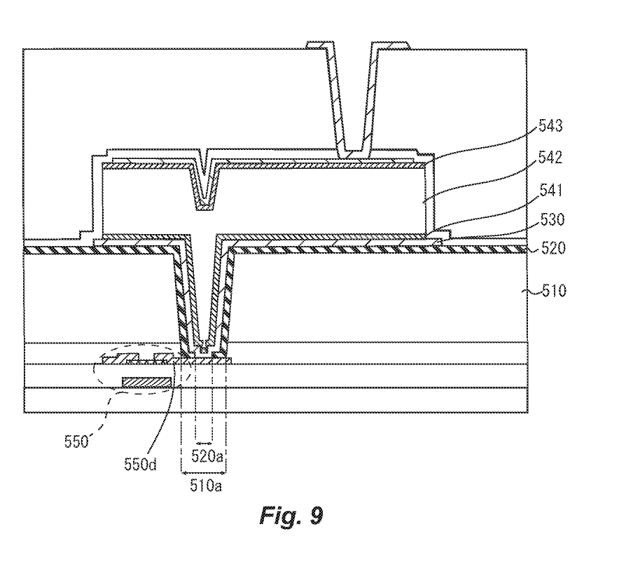

Since the photoelectric conversion layer 15 in the present embodiment is formed on an inner side with respect to the opening 21a of the insulating protection film 21 in this way, the width in the X-axis direction of the photoelectric conversion layer 15 is limited by the width of the opening 21a of the insulating protection film 21. In the present embodiment, however, the photoelectric conversion layer 15 does not overlap with the insulating protection film 21, and therefore, without controlling the shape of the end on the contact hole CH1 side of the insulating protection film 21 so that the end would be in a tapered shape, the lower electrode 14a can be completely covered with the n-type amorphous semiconductor layer 151. The necessity of controlling the shape of the end on the contact hole CH1 side of the insulating protection film 21 so that the end would be in a tapered shape is lower than that in Embodiment 1; for example, as illustrated in FIG. 8, the cross section of the end on the contact hole CH1 side of insulating protection film 21 may be therefore approximately vertical with respect to the insulating film 104. Incidentally, in a case where the end on the contact hole CH1 side of the insulating protection film 21 is approximately vertical with respect to the insulating film 104 as illustrated in FIG. 8, it is more difficult to cover the end of the insulating protection film 21 with the lower electrode 14a, as compared with the case of the tapered shape. Accordingly, it is preferable that the end of the insulating protection film 21 is controlled so as to be in a tapered shape as illustrated in FIG. 6.

The embodiments of the present invention described above are merely examples for implementing the present invention. The present invention, therefore, is not limited to the above-described embodiments, and the above-described embodiments can be appropriately varied and implemented without departing from the spirit and scope of the invention.

1. An imaging panel that generates an image based on scintillation light that is obtained from X-rays transmitted through an object, the imaging panel comprising:
a substrate;
a thin film transistor that is formed on the substrate;
an insulating resin film that is provided on the thin film transistor and has an opening on a drain electrode of the thin film transistor;
an insulating protection film that is arranged on an outer side with respect to the opening on the insulating resin film so as to be separated from the opening;
a lower electrode that is provided on the insulating resin film, overlaps with a part of the insulating protection film, and is connected with the drain electrode at the opening;
a photoelectric conversion layer that is provided on the lower electrode, and converts the scintillation light into charges; and
an upper electrode that is provided on the photoelectric conversion layer.

2. The imaging panel according to claim 1,
wherein a part of the photoelectric conversion layer overlaps with the lower electrode and the insulating protection film when viewed in a plan view, and
wherein an opening-side end of the insulating protection film has a tapered shape.

3. The imaging panel according to claim 1,
wherein the photoelectric conversion layer overlaps with the lower electrode and does not overlap with the insulating protection film when viewed in a plan view.

4. The imaging panel according to claim 3,
wherein an opening-side end of the insulating protection film has a tapered shape.

5. A method for producing an imaging panel that generates an image based on scintillation light that is obtained from X-rays transmitted through an object, the producing method comprising:
forming a thin film transistor on a substrate;
forming an insulating resin film on the thin film transistor, the insulating resin film having an opening at a position that overlaps with a drain electrode of the thin film transistor;
forming an inorganic insulating film on the insulating resin film;
applying a resist on the inorganic insulating film, and patterning the resist so that the resist is arranged on an outer side with respect to the opening so as to be separated from the opening, and ends of the resist have tapered shapes;
forming an insulating protection film outside the opening by etching the inorganic insulating film by using the resist as a mask;
forming, on the insulating resin film, a first transparent electrode film as a lower electrode that overlaps with a part of the insulating protection film and is connected with the drain electrode through the opening;
forming a first semiconductor layer of a first conductive type, an intrinsic amorphous semiconductor layer, and a second semiconductor layer of a second conductive type that is opposite to the first conductive type, in the stated order, as a photoelectric conversion layer on the insulating protection film and the first transparent electrode film;
forming an upper electrode on the second semiconductor layer;
applying a resist on the upper electrode, and etching the first semiconductor layer, the intrinsic amorphous semiconductor layer, and the second semiconductor layer, thereby forming the photoelectric conversion layer;
removing the resist, and forming a first insulating film that covers the upper electrode;
forming a contact hole on the upper electrode so that the contact hole passes through the first insulating film;
forming a second insulating film on the first insulating film except for a portion thereof of the contact hole;
forming a signal line for supplying a bias voltage, on the second insulating film;
forming a transparent conductive film that connects the signal line and the upper electrode with each other through the contact hole, on the second insulating film; and
forming a third insulating film that covers the transparent conductive film.
